(19) United States
(12) Patent Application Publication
(10) Pub. No.: US 2010/0057343 A1
(43) Pub. Date: Mar. 4, 2010

(54) APPARATUS AND METHOD FOR DISPLAYING GPS INTERFACE

(75) Inventors: Chun-Kai Chan, Taipei (TW); Fou-Ming Liou, Taipei (TW)

Correspondence Address: MORRIS MANNING MARTIN LLP, 3343 PEACHTREE ROAD, NE, 1600 ATLANTA FINANCIAL CENTER, ATLANTA, GA, 30326, US

(73) Assignee: ASUSTek Computer Inc., Taipei (TW)

(21) Appl. No.: 12/476,959

(22) Filed: Jun. 2, 2009

(30) Foreign Application Priority Data
Aug. 29, 2008 (TW) 097133164

(51) Int. Cl. G01C 21/36

(52) U.S. Cl. 701/201; 701/213

(57) ABSTRACT

The invention provides an apparatus and a method for displaying a GPS interface. The apparatus of the invention includes a GPS module and a processing module. The GPS module is capable of generating a command and the GPS interface. Furthermore, the processing module is coupled to the GPS module for detecting the command and selectively displaying the GPS interface on a display according to the command.

### BACKGROUND OF THE INVENTION

1. Field of the Invention

The present invention relates to an apparatus and method for displaying a GPS interface, and more particularly, to an apparatus and method for automatically displaying a GPS interface or a player program interface.

2. Description of the Prior Art

Along with the fast development of the technology, more and more technology-related products appear in our daily lives and assist us to handle our work and daily affairs so that lives become more convenient and work become more effective.

Taking the correlated technology of the GPS as an example, since the development of the military goal of the United States Department of Defense in 1970, the GPS with the advantages of being unaffected by weather conditions, accurate measurement, and easy operation, etc. has been widely applied to many different kinds of domains. The domains are like the monitor of natural environment (e.g. the monitor of earthquake, earth flow), land and surface navigation, zoology and botany care research (e.g. the monitor of environment of habitation and ways of migration), leisure activities (e.g. tourist track surveys and records of the mountain-climbing, sailing, light airliner flying), social security (e.g. the safety of the elders' and children's movement), and so on.

Moreover, the GPS construction mainly contains three major parts—an outer space monitoring system, a ground monitoring system and a client end. The outer space monitoring system contains approximately 30 satellites, and each satellite may launch a one-way signal to indicate its current position as well as the information of time. The ground monitoring system contains the inspection stations located around the world, and the inspection stations may issue instructions to make satellites maintain on the suitable tracks and adjust the satellites' clocks simultaneously. In addition, the inspection stations may also trace the satellites, upload the updated guidance data, and maintain the movement of the satellite groups as well as the arrangement condition. The client end usually contains the GPS receiving device; it may receive the signals of the afore-mentioned satellite and use the signals to compute the three-dimensional space position and the time of the client end.

The present GPS receiving device may be divided into two types. One is the individual navigation equipment that is combined to the portable electronics such as mobile phones, personal digital assistants, notebooks, and so on. The other type is the specific navigation equipment that is installed in a vehicle. Because of users' demands of multiple functions, navigation equipments usually contain other functions such as digital television players, video and music file players, and so on.

However, when using the fore-mentioned GPS receiving device to open the navigation program as well as other programs (e.g. television player program) simultaneously, the GPS receiving device only displays the navigation program interface or other program interface, and the user only transfers the interfaces manually, too. The GPS receiving device may simultaneously display two interfaces by picture in picture way; however, such a display mode is easy to cause the user to divert attention, and the pictures of each interface are not complete as well.

### SUMMARY OF THE INVENTION

Accordingly, an aspect of the present invention is to provide an apparatus and a method for displaying a GPS interface. Particularly, the apparatus and the method according to the invention can automatically switch between the GPS interface and the player program interface in the driving situation and does not need extra detection devices or complex electric circuits.

According to an embodiment, the method of the invention comprises the following steps: (a) detecting a command of a GPS program via an application program interface; and (b) displaying the GPS interface according to the command selectively by the application program interface. In an embodiment, the application program interface is able to establish the weighting of the GPS interface first. When the command of the GPS program works as the key command, the weighting of the GPS interface is adjusted according to the command. Finally, the method displays the GPS interface according to the weighting.

According to another embodiment, the apparatus of the invention comprises a GPS module and a processing module. The GPS module is able to generate a command and a GPS interface. In addition, the processing module is connected to the GPS module for detecting the command, and then, according to the command, selectively displaying the GPS interface on a monitor.

In an embodiment, the fore-mentioned processing module further comprises an application program interface module connected to the GPS module for detecting the command and establishing the weighting of the GPS interface. Specially, when the command is a key command, the application program interface module further adjusts the weighting of the GPS interface and displays the GPS interface on the monitor according to the weighting.

The objective of the present invention will no doubt become obvious to those of ordinary skill in the art after reading the following detailed description of the preferred embodiment, which is illustrated in the various figures and drawings.

### BRIEF DESCRIPTION OF THE APPENDED DRAWINGS

FIG. 1 shows a functional block of the apparatus for display the GPS interface according to an embodiment of the invention.

FIG. 2 shows a functional block of the apparatus for display the GPS interface according to an embodiment of the invention.

FIG. 3 shows a functional block of the apparatus for display the GPS interface according to an embodiment of the invention.

FIG. 4 shows a flow chart of the method for display the GPS interface according to an embodiment of the invention.

FIG. 5 shows a flow chart of the method for display the GPS interface according to an embodiment of the invention.

FIG. 6 shows a flow chart of the method for display the GPS interface according to an embodiment of the invention.

### DETAILED DESCRIPTION OF THE INVENTION

The present invention provides an apparatus and a method for displaying a GPS interface. The GPS interface usually contains the map block and the user operation block. The map block contains the map from the departure place to the destination as well as the driving route which is planed by the navigation system, and the user operation block contains the items which may be set by the user.

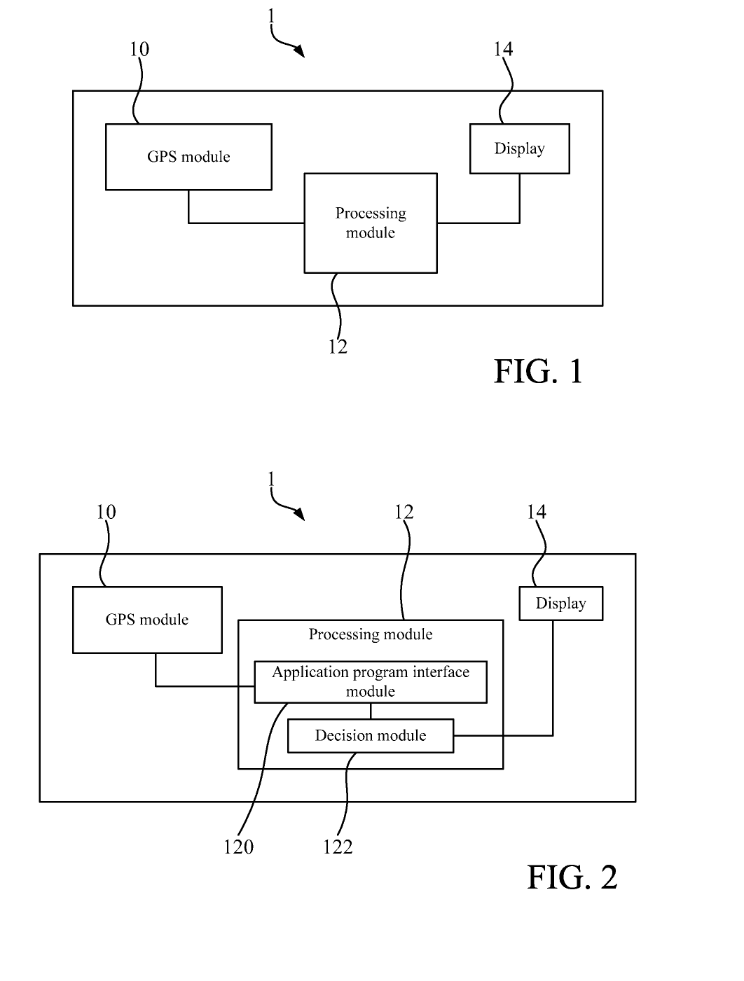

Please refer to FIG. 1, which shows a functional block of the apparatus for display the GPS interface according to an embodiment of the invention. As shown in FIG. 1, the apparatus 1 includes a global positioning system module (GPS module) 10, a processing module 12, and a display 14. The GPS module 10 can generate the fore-mentioned GPS interface, and the GPS module 10 might corporate with the prior mentioned satellite and the inspection station to measure time, latitude and longitude, height, speed, and other related data.

In practice, the GPS module 10 can obtain the current position of the apparatus 1 according to the above-mentioned data. Then, according to the current position as well as a default position (e.g., set by a user), the GPS module 10 plans a default route from the current position to the default positions. When the user operates the apparatus 1 and starts from the current position forwarding to the default position, the GPS module 10 will produce the commands consecutively to control driving instructions shown in the fore-mentioned map block and direct the user to forward along the default route.

In practice, the GPS module 10 will continually transmit the commands such as driving directions, distance, speed, and so on, to control the driving instructions shown on the map block. For example, when GPS module 10 transmits a left-turn command, the map block will inform the driver in words or images to turn left. For another example, when the GPS module 10 detects that the present vehicle speed surpasses a predetermined value, it may transmit a caution command, and the map block will inform the driver in words or images of decelerating driving.

Furthermore, the processing module 12 is connected to the GPS module 10 for detecting the command transmitted by the GPS module 10, and according to the command, selectively displaying the GPS interface on the display 14. In practice, when the GPS module 10 transmits a predetermined key command (such as but not limited to a left-turn command, a right-turn command, and a caution command), the processing module 12 displays the GPS interface on the display 14. On the contrary, when the GPS module 10 transmits a non-key command (such as but not limited to a direct driving command), the processing module 12 does not display the GPS interface on the display 14. In practice, either the manufacturers of the apparatus of the invention or the users of the apparatus can set the key commands or non-key commands based on their needs. The commands are not limited to the above-mentioned illustrations. In addition, in practice, the processing module 12 may detect the commands generated by the GPS module 10 by polling or other suitable ways.

Furthermore, please refer to FIG. 2, which shows a functional block of the apparatus for display the GPS interface according to an embodiment of the invention. As shown in FIG. 2, the apparatus 1 also comprises the fore-mentioned GPS module 10, processing module 12, and the display 14. Particularly, the processing module 12 further comprises an application program interface module 120 and a decision module 122.

The application program interface module 120 is connected to the GPS module 10 for detecting the command generated by the GPS module 10 and setting the weighting of the GPS interface. In addition, when the command is the key command, the application program interface module 120 will adjust the weighting of the GPS interface according to the detected command. The decision module 122 is connected to the application program interface module 120 and the display 14 for receiving the weighting of the GPS interface from the application program interface module 120. Further, according to the weighting, the decision module 122 may selectively display the GPS interface on the display 14.

In practice, the decision module 122 may compare the weighting with a predetermined value. And, according to a criterion (e.g., if the weighting is or is not the same as the predetermined value), it will decide whether or not to display the GPS interface on the display 14. For example, assume that the predetermined value is “0”, and the criterion is that when the weighting is different from the predetermined value, show the GPS interface on the display 14. Therefore, when the application program interface module 120 detects a key command from the GPS module 10, the weighting of the GPS interface will be adjusted to be “1”. Further, the decision module 122 will receive the weighting “1” and compares with the predetermined value “0”. In this case, because the weighting “1” is different from the predetermined value “0”, the decision module 122 will display the GPS interface on the display 14.

Please note that, in practice, the steps carried out by the fore-mentioned decision module 122 may also be completed by the application program interface module 120.

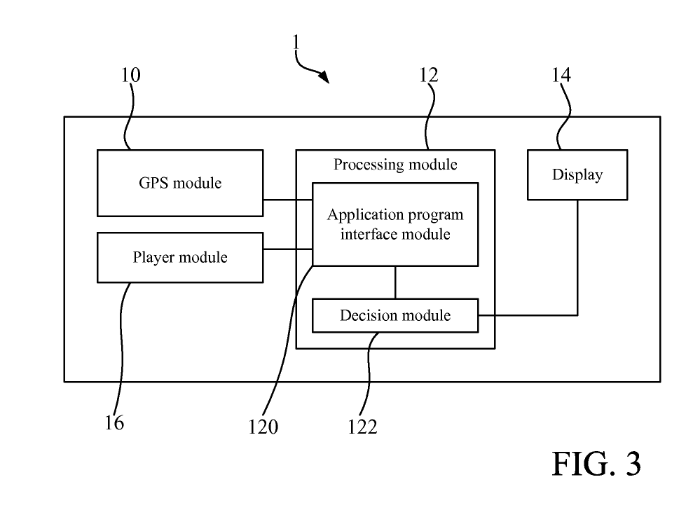

Please refer to FIG. 3, which shows a functional block of the apparatus for display the GPS interface according to an embodiment of the invention. As shown in FIG. 3, the apparatus 1 comprises the fore-mentioned GPS module 10, the processing modules 12, and the display 14. The processing module 12 comprises the application program interface module 120 and the decision module 122. Specially, in the embodiment, the apparatus 1 of the invention further comprises the player module 16 which is connected with the application program interface module 120 and can generate a player interface. In practice, the player interface usually comprises a player block and a user operation block. The player block may display images, movies, television programs, etc., broadcasted by the program module 16. And, the user operation block is able for a user to broadcast the signals or the files such as images, movies, music, television programs, and broadcast programs.

In the embodiment, the application program interface module 120 can set the weighting of the player interface, and the decision module 122 can receive and compare the weighting of the player interface with that of the GPS interface, and according to a criterion decide to display the GPS interface or the player interface on the display 14. Practically, the player interface can be, but is not limited to, a television player interface, a disc player interface, a movie player interface and a music broadcast program interface.

For example, the application program interface module 120 presets both of the default weightings of the GPS interface and the player interface to be “5”, and the criteria of the decision module 122 is that when the weighting of the GPS interface is larger than the weighting of the player interface, the apparatus display the GPS interface on the display 14. On the contrary, when the weighting of the GPS interface is smaller than the weighting of the player interface, the apparatus display the GPS interface on the display 14.

Accordingly, when the GPS module transmits the key command as mentioned above, the application program interface module 120 adjusts the weighting of the GPS interface to be “7”. In said case, the decision module 122 compares the weighting of the GPS interface (“7”) with that of the player interface (“5”), and then discovers that the weighting of the GPS interface is larger than that of the player interface. Accordingly, the GPS interface is displayed on the display 14. On the contrary, when the GPS module transmits a non-key command as mentioned above, the application program interface module 120 adjusts the weighting of the GPS interface to be “3”. In said case, the decision module 122 compares the weighting of the GPS interface (“3”) with that of the player interface (“5”), and then discovers that the weighting of the GPS interface is smaller than that of the player interface. Accordingly, the player interface is displayed on the display 14.

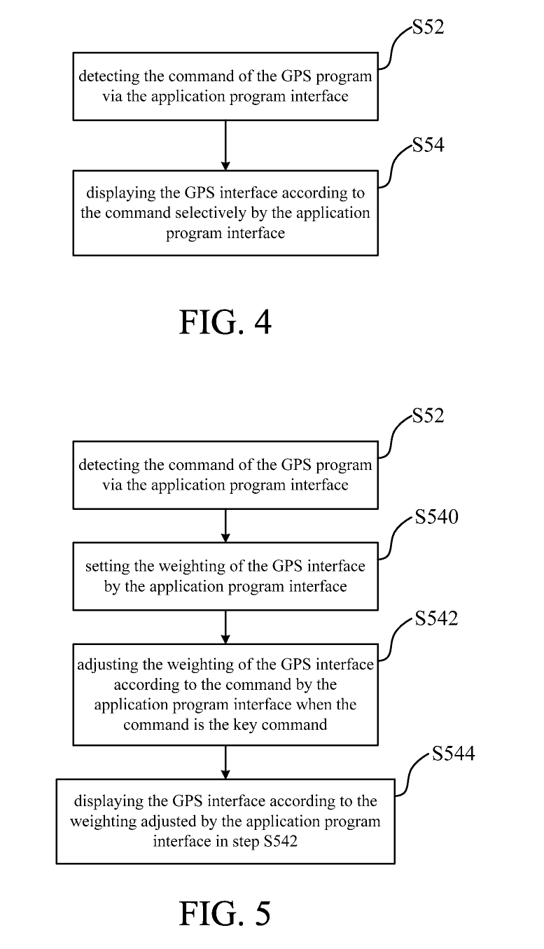

The invention also provides a method for displaying a GPS interface. Please refer to FIG. 4, which shows a flow chart of the method for display the GPS interface according to an embodiment of the invention. As shown in FIG. 4, the method comprises the following steps: step S52, detecting the command of the GPS program via the application program interface; and step S54, displaying the GPS interface according to the command selectively by the application program interface. In practice, step S52 may detect the command of the GPS program by polling or other suitable ways. As mentioned above, in practice, step S54 may display the GPS interface when the command is the key command (i.e. the fore-mentioned left-turn command, right-turn command, and so on). Or, in practice, step S54 may not display the GPS interface or display the other program interface when the command is the non-key command (i.e. the fore-mentioned direct driving command).

Please refer to FIG. 5, which shows a flow chart of the method for display the GPS interface according to an embodiment of the invention. As shown in FIG. 5, in the embodiment, step S54 of FIG. 4 may further comprise the following steps : step S540, setting the weighting of the GPS interface by the application program interface; step S542, when the command is the key command (i.e. the fore-mentioned left-turn command, right-turn command, and so on), adjusting the weighting of the GPS interface according to the command by the application program interface; and step S544, displaying the GPS interface according to the adjusted weighting selectively by the application program interface in step S542. As mentioned above, step S544 can compare the weighting and the predetermined value to decide whether or not to display the GPS interface. Certainly, in practice, step S544 can decide whether to display the GPS interface according to the weighting of other mechanisms.

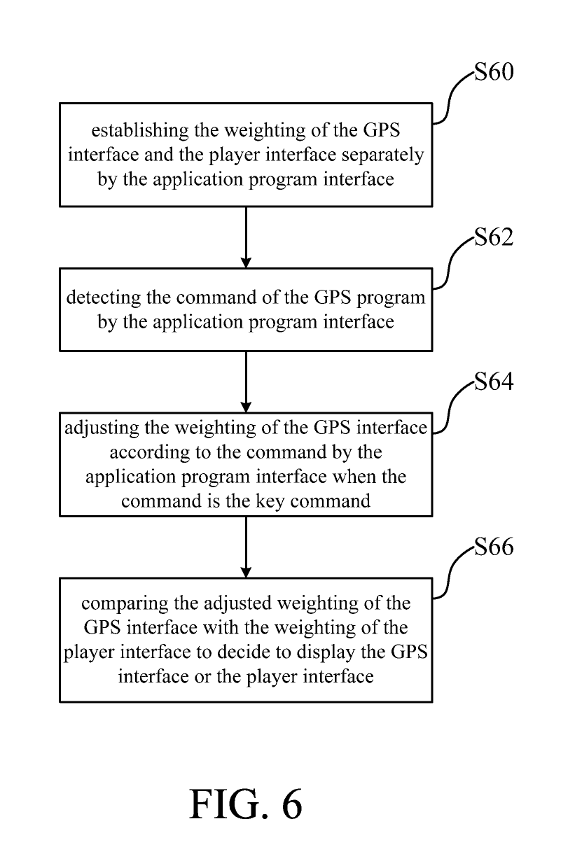

Please refer to FIG. 6, which shows a flow chart of the method for display the GPS interface according to an embodiment of the invention. As shown in FIG. 6, in the embodiment, the method of the invention further comprises the following steps: step S60, establishing the weighting of the GPS interface and the player interface separately by the application program interface; step S62, detecting the command of the GPS program by the application program interface; step S64, when the command is the key command (i.e. the fore-mentioned left-turn command, right-turn command, and so on), adjusting the weighting of the GPS interface according to the command by the application program interface; and step S66, comparing the adjusted weighting of the GPS interface with the weighting of the player interface to decide to display the GPS interface or the player interface. As mentioned above, by comparing whether the adjusted weighting of the GPS interface is the same as that of the player interface, step S66 can decide to display the GPS interface or the player interface. Certainly, in practice, step S66 may also display the GPS interface or the player interface according to other mechanisms.

As mentioned above, the player interface may be, but is not limited to, the television player interface, the disc player interface, the movie player interface, and the music player interface. In addition, in practice, the order of the fore-mentioned steps may be adjusted or changed, and not limited to the examples.

To sum up, the invention provides an apparatus and a method for displaying a GPS interface which can operate the GPS program or the player program simultaneously based upon the commands generated by the GPS program. Compared with the prior arts, the apparatus and method of the invention may achieve the goal of automatic switching between the GPS interface and the player interface via simple steps of judgment, which not only provides drivers convenience but also improves traffic safety.

Although the present invention has been illustrated and described with reference to the preferred embodiment thereof, it should be understood that it is in no way limited to the details of such embodiment but is capable of numerous modifications within the scope of the appended claims.

What is claimed is:

1. A method for displaying a GPS interface, the method comprising the following steps:
(a) detecting a command of a GPS program via an application program interface; and
(b) displaying the GPS interface according to the command selectively by the application program interface.

2. The method of claim 1, wherein step (b) further comprises the following steps:
(b1) setting a first weighting of the GPS interface by the application program interface;
(b2) adjusting the first weighting of the GPS interface according to the command by the application program interface when the command is a key command; and
(b3) displaying the GPS interface according to the first weighting adjusted by the application program interface in step (b2).

3. The method of claim 2, wherein the key command comprises a left-turn command or a right-turn command.

4. The method of claim 2, further comprising the following steps:
(b11) setting a second weighting of a player interface by the application program interface; and
(b31) determining to display the GPS interface or the player interface by comparing the first weight with the second weighting by the application program interface.

5. The method of claim 4, wherein the player interface comprises one selected from the group consisting of a television player interface, a disc player interface, a movie player interface and a music player interface.

6. The method of claim 1, wherein when the command is a key command, step (b) displays the GPS interface.

7. The method of claim 6, wherein the key command comprises a left-turn command or a right-turn command.

8. The method of claim 1, wherein when the command is a non-key command, step (b) does not display the GPS interface.

9. The method of claim 8, wherein the non-key command comprises a moving-ahead command.

10. The method of claim 1, wherein the GPS program receives a current position of an user, and plans, according to the current position and a default position, a default route from the current position to the default position, wherein when the user moves from the current position to the default position, the GPS program continuously generates the command to guide the user to move along the default route.

11. The method of claim 1, wherein step (a) detects the command of the GPS program by polling.

12. An apparatus for displaying a GPS interface, the apparatus comprising:
a GPS module for generating a command and the GPS interface; and
a processing module, connected to the GPS module, for detecting the command, and
selectively displaying the GPS interface on a display according to the command.

13. The apparatus of claim 12, wherein the processing module further comprises:
an application program interface module, connected to the GPS module, for detecting the command and setting a first weighting of the GPS interface;
wherein when the command is a key command, the application program interface module further adjusts the first weighting of the GPS interface according to the command, and
displays the GPS interface on the display according to the adjusted first weighting.

14. The apparatus of claim 13, wherein the key command comprises a left-turn command or a right-turn command.

15. The apparatus of claim 13 further comprising:
a player module connected to the application program interface module, the player module generating a player interface, and the application program interface module setting a second weighting of the player interface; and
a determining module connected to the application program interface module, for receiving the first weighting and the second weighting, and comparing the first weighting with the second weighting to determine to display the GPS interface or the player interface on the display.

16. The apparatus of claim 15, wherein the player interface comprises one selected from the group consisting of a television player interface, a disc player interface, a movie player interface and a music player interface.

17. The apparatus of claim 12, wherein when the command is a key command, the processing module displays the GPS interface on the display.

18. The apparatus of claim 17, wherein the key command comprises a left-turn command or a right-turn command.

19. The apparatus of claim 12, wherein the GPS module receives a current position of the apparatus, and plans, according to the current position and a default position, a default route from the current position to the default position, wherein when an user operates the apparatus and moves from the current position to the default position, the GPS module continuously generates the command to guide the user to move along the default route.

20. The apparatus of claim 12, wherein the processing module detects the command of the GPS module by polling.
